(19) United States
(12) Patent Application Publication
(10) Pub. No.: US 2009/0012890 A1
(43) Pub. Date: Jan. 8, 2009

(54) SYSTEM AND METHOD FOR CONFIRMING ELECTRONIC SERVICE

(76) Inventors: Shiyong WANG, Beijing (CN); Yuhua Zheng, Beijing (CN)

Correspondence Address: LADAS & PARRY LLP, 224 SOUTH MICHIGAN AVENUE, SUITE 1600, CHICAGO, IL, 60604, US

(21) Appl. No.: 12/233,746

(22) Filed: Sep. 19, 2008

Related U.S. Application Data
(63) Continuation of application No. PCT/CN2007/000856, filed on Mar. 16, 2007.

(30) Foreign Application Priority Data
Mar. 22, 2006 (CN) 200610058587.7

(51) Int. Cl. G06Q 40/00; H04B 1/00; G06F 17/30

(52) U.S. Cl. 705/35; 455/68; 707/3

(57) ABSTRACT

A system and method for confirming an electronic service are provided. The system includes an electronic service application system, adapted to send an electronic service confirmation request to a confirmation center when implementing an electronic service, and implement the electronic service according to an electronic service confirmation result from the confirmation center; the confirmation center, adapted to determine a confirmation terminal corresponding to the electronic service confirmation request, send an electronic service confirmation message to the confirmation terminal, and send the electronic service confirmation result from the confirmation terminal to the electronic service application system; the confirmation terminal, adapted to receive the electronic service confirmation message, generate the electronic service confirmation result according to feedback from a user, and send the electronic service confirmation result to the confirmation center. The occurrence of the electronic service can be monitored and the security of the electronic service is greatly improved.

### FIELD OF THE INVENTION

The present invention relates to electronic service technologies, and particularly, to a method and system for confirming an electronic service.

### BACKGROUND OF THE INVENTION

Because of the merits such as convenience, lower cost and cross-regions, the electronic service is developing very rapidly. The electronic service includes various representing forms, such as electronic business, mobile business, and electronic government. Although the electronic service is developing quickly, the occurrence of the electronic service is finished automatically without the presence and participation of a person, which may cause series of security problems. For example, in an online electronic service, e.g. online transaction and online payment, because the physical signature of a user can not be obtained and the identify of the user can be only checked according to the user name and password, it is difficult for a bank and a merchant to ensure the validity of the identify of the user who uses the online transaction and online payment, which gives a chance to cheating while brings a tremendous amount of economic loss to the bank, the credit card company, the merchant and the cardholder.

According to an authoritative survey and statistics, the loss due to credit card cheating in the United States in 2003 is 2.37 billion dollars, including the loss due to online cheating 1.23 billion dollars; and the global loss due to card cheating in 2002 even reaches 3.8 billion dollars. Further, according to the statistics from Lpsos-Insights in January, 2004, about 70% users are afraid to pay online using the cards.

Therefore, a notification and confirmation method is urgently needed to monitor the occurrence of the electronic service, which is safe and convenient. For example, when the amount in a bank account is reduced, the cardholder or authorized monitor would be notified automatically by the method; and it is permitted to transfer money from the bank account only after the confirmation from the cardholder or authorized monitor is received. In addition, as to series of systems such as customs, freight, aviation, orders, various official replies, related information in the systems is sent to a person by conventional mail or telephone or is initiatively queried for by the person, and thus a new manner is needed to automatically inform a relevant person and receive a reply (confirmation) result from the relevant person

At present, in the prior art, there is a method for notifying data change in the electronic service by a short message of a mobile phone. In the method, when some important data, such as the amount in a bank account, are changed, the system where the electronic service occurs sends a short message to the mobile phone of a relevant person through a mobile phone gateway to notify the relevant person. If the notified relevant person finds something wrong, the notified relevant person performs a corresponding operation such as query by telephone. In the method, because the mobile phone only displays the short message and does not perform a further operation on the short message, the method can not manage the occurrence of the electronic service but only can know the occurrence of the electronic service after the electronic service occurs. Therefore, the method in the prior art can not monitor the electronic server and can not ensure the security of the electronic server either.

### SUMMARY OF THE INVENTION

In view of the above, one aspect of the present invention provides a system for confirming an electronic service, which can monitor the occurrence of the electronic service and improve the security of the electronic service.

In view of the above, another aspect of the present invention provides a method for confirming an electronic service, which can monitor the occurrence of the electronic service and improve the security of the electronic service.

In view of the above, another aspect of the present invention provides a confirmation center of an electronic service, which can monitor the occurrence of the electronic service and improve the security of the electronic service.

In view of the above, another aspect of the present invention provides a confirmation terminal, which can monitor the occurrence of an electronic service and improve the security of the electronic service.

To attain the above aspects, the technical solutions of the present invention are given as follows.

According to one aspect, a system for confirming an electronic service includes: an electronic service application system, a confirmation center and a database; where

the electronic service application system is adapted to send an electronic service confirmation request to the confirmation center when implementing an electronic service, and implement the electronic service according to an electronic service confirmation result from the confirmation center;

the confirmation center is adapted to determine the confirmation terminal corresponding to the electronic service confirmation request, send an electronic service confirmation message to the confirmation terminal, and send the electronic service confirmation result from the confirmation terminal to the electronic service application system; and

the confirmation terminal is adapted to receive the electronic service confirmation message, generate the electronic service confirmation result according to feedback from a user, and send the electronic service confirmation result to the confirmation center.

According to another aspect, a confirmation center of an electronic service includes one or more components adapted to:

receive an electronic service confirmation request from an electronic service application system, determine a confirmation terminal corresponding to the electronic service confirmation request, send an electronic service confirmation message to the confirmation terminal in a communication mode registered by the confirmation terminal, and send to the electronic service application system an electronic service confirmation result from the confirmation terminal.

According to yet another aspect, a mobile terminal includes one or more components adapted to:

receive an electronic service confirmation message from a confirmation center of an electronic service, generate an electronic service confirmation result according to feedback from a user, and send the electronic service confirmation result to the confirmation center.

According to yet another aspect, a method for confirming an electronic service includes:

sending, by an electronic service application system, an electronic service confirmation request to a confirmation center when implementing an electronic service;

determining, by the confirmation center, a confirmation terminal corresponding to the electronic service confirmation request, and sending an electronic service confirmation message to the confirmation terminal;

providing, by the confirmation terminal, the electronic service confirmation message to a user, generating an electronic service confirmation result according to feedback from the user, and sending the electronic service confirmation result to the confirmation center;

sending, by the confirmation center, the electronic service confirmation result from the confirmation terminal to the electronic service application system; and

implementing, by the electronic service application system, the electronic service according to the electronic service confirmation result.

As can be seen from the above, the system for confirming an electronic system includes the electronic service application system, the confirmation center and the confirmation terminal. The confirmation terminal generates the electronic service confirmation result according to the feedback from the user, and sends the electronic service confirmation result to the confirmation center. The confirmation center sends the electronic service confirmation result to the electronic service application system. The electronic service application system implements the electronic service according to the electronic service confirmation result. Therefore, through the interaction among the electronic service application system, the confirmation center and the confirmation terminal, the occurrence of the electronic service is monitored timely, which is different from the conventional method of notifying the user after the electronic service is finished, and the security of the electronic service is therefore improved greatly according to the present invention.

### BRIEF DESCRIPTION OF THE DRAWINGS

FIG. 1 is a schematic diagram illustrating an exemplary structure of a system for confirming an electronic service in accordance with an embodiment of the present invention.

FIG. 2 is a schematic diagram illustrating an exemplary structure of a confirmation center in accordance with an embodiment of the present invention.

FIG. 3 is a schematic diagram illustrating an exemplary structure of a system for confirming an electronic service in accordance with an embodiment of the present invention.

FIG. 4 is a flowchart illustrating a method for confirming an electronic service in accordance with an embodiment of the present invention.

FIG. 5 is a schematic diagram illustrating an electronic service confirmation service in accordance with an embodiment of the present invention.

FIG. 6 is a flowchart illustrating a method of a user registering an electronic service confirmation notification in accordance with an embodiment of the present invention.

FIG. 7 is a flowchart illustrating a method of a user testing an electronic service confirmation notification in accordance with an embodiment of the present invention.

FIG. 8 is a flowchart illustrating a method of a user binding an electronic service confirmation notification in accordance with an embodiment of the present invention.

FIG. 9 is a schematic illustrating User-Centered Design (UCD) of a user in accordance with an embodiment of the present invention.

FIG. 10 is a schematic illustrating the UCD of a confirmation center in accordance with an embodiment of the present invention.

FIG. 11 is a schematic illustrating the UCD of an electronic service application system in accordance with an embodiment of the present invention.

### DETAILED DESCRIPTION OF THE INVENTION

The present invention is hereinafter described in detail with reference to the accompanying drawings as well as embodiments so as to make the objective, technical solution and merits thereof more apparent.

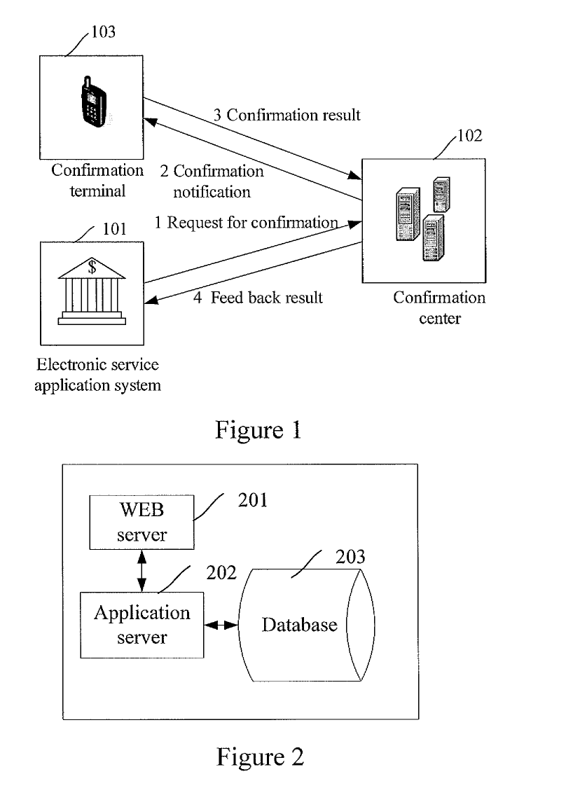

FIG. 1 is a schematic diagram illustrating an exemplary structure of a system for confirming an electronic service in accordance with an embodiment of the present invention. As shown in FIG. 1, the system for confirming the electronic service includes: an electronic service application system 101, a confirmation center 102 and a database.

The electronic service application system 101 is adapted to send an electronic service confirmation request to the confirmation center 102 when implementing the electronic service, and implement the electronic service according to an electronic service confirmation result from the confirmation center 102.

The confirmation center 102 is adapted to determine the confirmation terminal 103 corresponding to the electronic service confirmation request, send an electronic service confirmation message to the confirmation terminal 103, and send the electronic service confirmation result from the confirmation terminal 103 to the electronic service application system 101.

The confirmation terminal 103 is adapted to receive the electronic service confirmation message, generate the electronic service confirmation result according to feedback from a user, and send the electronic service confirmation result to the confirmation center 102.

The confirmation center 102 may send the electronic service confirmation message to the confirmation terminal through a protocol such as a Short Message Service (SMS) protocol, a Socket protocol or a Datagram protocol. The electronic service confirmation result from the confirmation terminal 103 may be sent to the electronic service application system 101 through the manner of the SMS or a Hyper Text Transport Protocol (HTTP). Those skilled in the art can understand that, although some specific protocols and implementation manners are described above, the present invention does not limit the manner of the confirmation center 102 sending the electronic service confirmation message to the confirmation terminal or the manner of the confirmation terminal 103 sending the electronic service confirmation result to the electronic service application system 101. Preferably, the confirmation terminal 103 may firstly register a corresponding communication mode in the confirmation center 102, and then the confirmation terminal 103 and the confirmation center 102 communicate with each other through the communication mode.

The electronic service application system 101 may be any electronic service running system or any electronic service operation system. Specifically, the electronic service application system 101 may be a bank account monitoring system, a telephone-banking transaction system, a network-banking transaction system, an electronic transaction system, a liquid assets monitoring system, or a network cryptograph protection system. Specifically, the network cryptograph protection system may be e-mail systems or online game systems in various modes. Therefore, the present invention may provide further protection for the e-mail and the online games so as to prevent invalid logon.

The confirmation terminal 103 may be an entity with a communication function, such as a mobile telephone, a Personal Digital Assistant (PDA), a Personal Computer (PC) and a laptop computer.

Specifically, the confirmation terminal 103 includes a communication module adapted to receive and send information on electronic service confirmation, and an electronic service confirmation module adapted to generate the electronic service confirmation result according to the electronic service confirmation message and the feedback from the user. The electronic service confirmation message may be a JAVA program running in the confirmation terminal 103. Preferably, the JAVA program (MIDlet) may be downloaded and automatically installed in the confirmation terminal 103 through a remote configuration mode such as Over-The-Air (OTA). The JAVA program in the confirmation terminal 103 need not be started in general, and the JAVA program is activated by the confirmation center 102 by way of Push Registry if the confirmation is needed.

The Push Registry is a new function of the MIDlet 2.0, and is a new mechanism which makes the MIDlet be activated by a connection of the server side or a timer. By this technique, when a certain event happens, the MIDlet in the mobile terminal is started automatically by the server side without the participation of the user.

In the embodiment of the present invention, the JAVA program in the confirmation terminal 103 listens to a message containing a port number such as port 6000; when receiving an SMS message containing port 6000, the Application Management Software (AMS) launches the JAVA program in the confirmation terminal 103 (sms://:6000). Upon receiving the confirmation request from the electronic service application system 101, the confirmation center 102 sends the short message to the interface 6000 of the corresponding confirmation terminal 103. When activated by the short message on the interface 6000, the JAVA program starts running, receiving and processing the short message.

In the above description, although the JAVA language is taken as an example to describe how to realize the function of the confirmation terminal, those skilled in the art should understand that the present invention is not limited to the JAVA language, but is also applicable to various object oriented programming languages, such as C language, C++ language and PASCAL language.

The confirmation center 102 is the core of the whole system, and is adapted to provide the confirmation service for the electronic service application system 101. Upon receiving the confirmation request from the electronic service application system 101, the confirmation center 102 transmits the confirmation request to the corresponding confirmation terminal 103. Upon receiving the confirmation result from the confirmation terminal 103, the confirmation center 102 notifies the corresponding electronic service application system 101 of the confirmation result.

FIG. 2 is a schematic diagram illustrating an exemplary structure of a confirmation center in accordance with an embodiment of the present invention. As shown in FIG. 2, the confirmation center includes:

a Web server 201, adapted to receive the electronic service confirmation request, manage an application server 202 to query a database 203 for a confirmation terminal corresponding to the electronic service confirmation request, send the electronic service confirmation message to the confirmation terminal in a communication mode registered by the confirmation terminal, and send the electronic service confirmation result from the confirmation terminal to the electronic service application system;

the application server 202, adapted to query the database 203 for the identity ID and the communication mode of the confirmation terminal according to a command from the Web server;

the database 203, adapted to store the ID of the confirmation terminal, the electronic service confirmation message and the electronic service confirmation result.

The Web server 201 is further adapted to receive the user's registration of a confirmation service via an Internet Web connection of the confirmation terminal, and/or the application server 202 is adapted to query the database 203 for private information of the user and/or modify the private information of the user according to a request from the Web server 201. The user may download the JAVA program from the Web server 201 into the confirmation terminal. In addition, the Web server 201 saves a confirmation request from the electronic service application system 101 and the confirmation result from the confirmation terminal 103 into the database 203 via the application server 202.

The Web server may be replaced by a Socket server. The Socket server receives the user's registration via the Internet Socket connection of the confirmation terminal, and/or the application server 202 is adapted to query the database 203 for private information of the user and/or modify the private information of the user according to a request from the Socket server.

Specifically, the application server 202 processes the request from the Web server. For example, the application server 202 queries for/modifies the private information of the user, saves the confirmation request from the electronic service application system and the confirmation result from the confirmation terminal. The database 203 stores various information of the whole system, such as the private information of the user, the confirmation request from the electronic service application system 101 and the confirmation result from the confirmation terminal 103.

Those skilled in the art should understand that the structure of the confirmation center described in detail above is an embodiment of the present invention not for use in limiting the protection scope of the present invention. For example, a server supporting both Web and Socket may be used as an external interface of the confirmation center only if the server can support the information transmission according to both the Internet and the mobile communication.

In other words, the confirmation center may generally include: an information transmission server, an application server and a database. The information transmission server is adapted to receive the electronic service confirmation request, manage the application server to query the database for a corresponding confirmation terminal, send the electronic service confirmation message to the confirmation terminal in a communication mode registered by the confirmation terminal, and send the electronic service confirmation result from the confirmation terminal to the electronic service application system. The application server is adapted to query the database for the ID and the communication mode of the confirmation terminal according to an instruction from the information transmission server. The database is adapted to store the ID of the confirmation terminal, the electronic service confirmation message and the electronic service confirmation result.

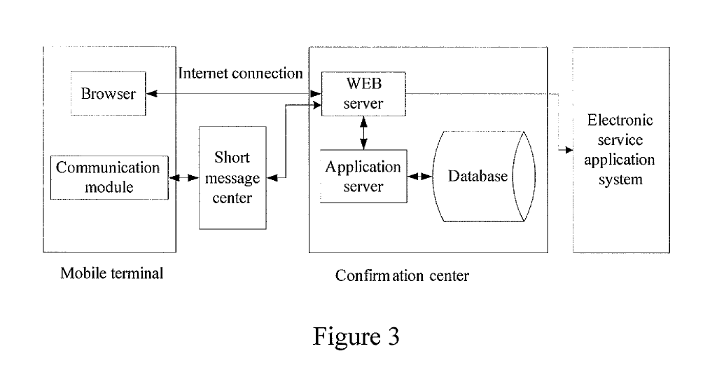

Combining FIG. 1 and FIG. 2, FIG. 3 is a schematic diagram illustrating an exemplary structure of a system for confirming an electronic service in accordance with an embodiment of the present invention. As shown in FIG. 3, the mobile terminal may use a browser in itself to register an electronic service confirmation service in the Web server of the confirmation center. When the electronic service confirmation service is registered, the mobile terminal can monitor the occurrence of an electronic service.

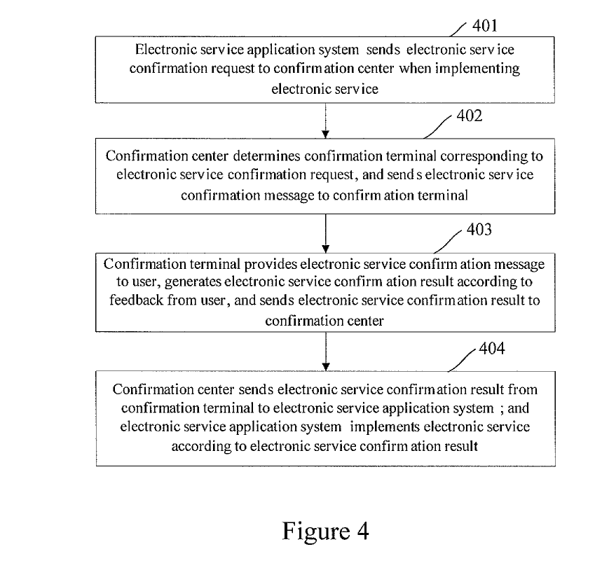

FIG. 4 is a flowchart illustrating a method for confirming an electronic service in accordance with an embodiment of the present invention. As shown in FIG. 4, the method is described below.

Block 401: When implementing an electronic service, the electronic service application system sends an electronic service confirmation request to a confirmation center.

Block 402: The confirmation center determines a confirmation terminal corresponding to the confirmation request according to the electronic service confirmation request, and sends an electronic service confirmation message to the confirmation terminal.

Block 403: The confirmation terminal indicates the electronic service confirmation message to a user, generates an electronic service confirmation result according to feedback from the user, and sends the electronic service confirmation result to the confirmation center.

Block 404: The confirmation center sends the electronic service confirmation result from the confirmation terminal to the electronic service application system, and the electronic service application system implements the electronic service according to the electronic service confirmation result.

In the above process, a triggering condition of confirming the electronic service may be pre-set in the electronic service application system. When implementing the electronic service, only when the triggering condition of confirming the electronic service is satisfied, the electronic service application system sends the electronic service confirmation request to the confirmation center. If the triggering condition of confirming the electronic service is not satisfied, the electronic service application system does not send the confirmation request to the confirmation center.

Preferably, the confirmation center sends to the confirmation terminal the electronic service confirmation message which is encrypted, and the confirmation center sends the electronic service confirmation message to the confirmation terminal in a short message. Upon receiving the electronic service confirmation result, the electronic service application system determines whether the electronic service is allowed according to the electronic service confirmation result. If the electronic service is allowed, the electronic service is implemented; otherwise, the electronic service is implemented.

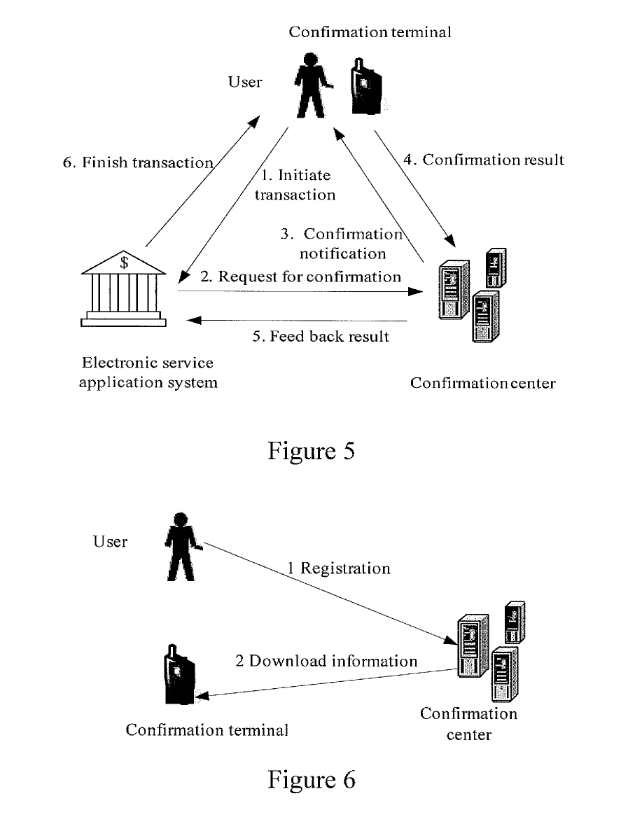

FIG. 5 is a schematic diagram illustrating an electronic service confirmation service in accordance with an embodiment of the present invention. It is supposed that the electronic service is transferring money from an account in the network banking mode.

When performing a transaction, an electronic service application system determines whether it is necessary to notify a user to confirm the transaction according to a condition preset by the user. If it is not necessary to notify the user to confirm the transaction, the transaction is implemented according to the conventional manner. If it is necessary to notify the user to confirm the transaction, the electronic service application system generates notification information, and sends a confirmation request to the confirmation center. The confirmation center caches the confirmation request in a database, and searches for a corresponding confirmation terminal according to the ID in the confirmation request, where the ID in the confirmation request and the confirmation terminal may be bound together in the database during the registration. The confirmation center sends the information to be confirmed to the corresponding confirmation terminal in a short message. And then JAVA program in the confirmation terminal is activated by the short message and starts running. Specifically, the JAVA program displays information of the confirmation request, waits for the confirmation from the user, generates information of the confirmation result according to the confirmation result from the user, and sends the information of the confirmation result to the confirmation center. The confirmation center updates the corresponding record of the confirmation request in the database, and sends the confirmation result to the electronic service application system.

Finally, the electronic service application system implements or refuses the transaction of the user according to the confirmation result.

The process of the user registering an electronic service confirmation notification is described in detail hereinafter. FIG. 6 is a flowchart illustrating a method of a user registering an electronic service confirmation notification in accordance with an embodiment of the present invention.

As shown in FIG. 6, the user may log on the Website of the confirmation center via a browser, select a valid ID, set a password and provide private information such as the number of the mobile terminal, and submit the registration. When the registration is successful, a confirmation center sends information on downloading the JAVA program to the corresponding confirmation terminal. If there is not the JAVA program in the mobile terminal of the user, the JAVA program is automatically downloaded and installed in the mobile terminal. If there is the JAVA program in the mobile terminal of the user, the registration is finished.

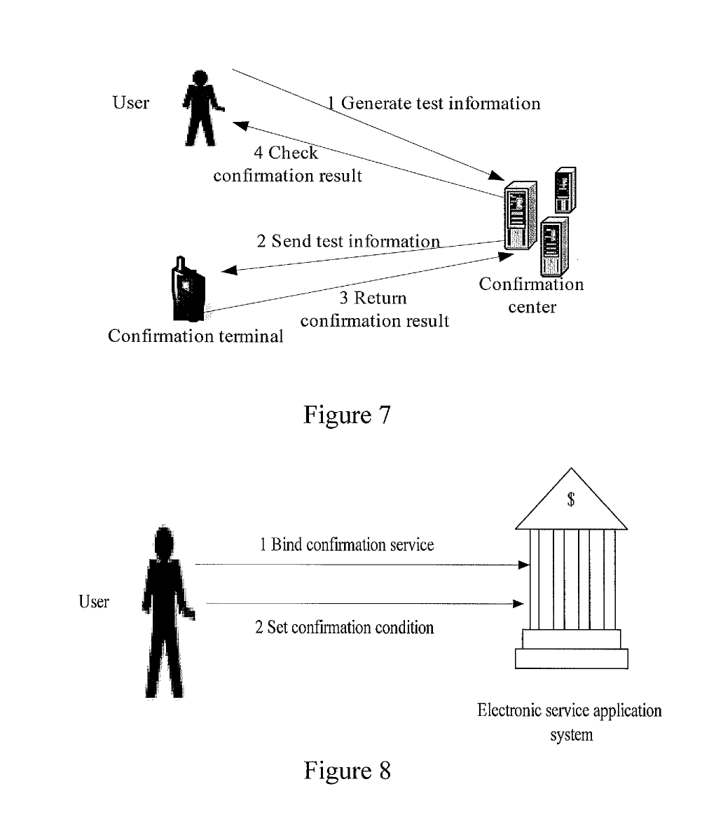

The process of a user testing an electronic service confirmation notification is described in detail hereinafter. FIG. 7 is a flowchart illustrating a method of a user testing an electronic service confirmation notification in accordance with an embodiment of the present invention.

As shown in FIG. 7, the user may log on the Website of a confirmation center via a browser, and generate information on testing the JAVA program. The confirmation center sends the information on testing the JAVA program to the mobile terminal of the user. The user confirms the information on testing the JAVA program, and checks the confirmation result on the Website of the confirmation center via the browser to determine whether the test is successful.

The process of a user binding the electronic service confirmation notification is described in detail hereinafter. FIG. 8 is a flowchart illustrating a method of a user binding an electronic service confirmation notification in accordance with an embodiment of the present invention.

As shown in FIG. 8, the user may enter the electronic service application system by telephone, on network or by other ways, and bind the ID with an account of the electronic service application system. For example, in an electronic-banking system, the ID is bound with a bank account and the user sets a trigger condition of confirming the electronic service, and thus the binding is finished. For another example, if the money transferred from an account at one time reaches 100 Yuan or the total money transferred from the account in one day reached 200 Yuan, it is necessary to notify the holder of the account and wait for the confirmation from the holder; otherwise, it is not necessary to notify the holder.

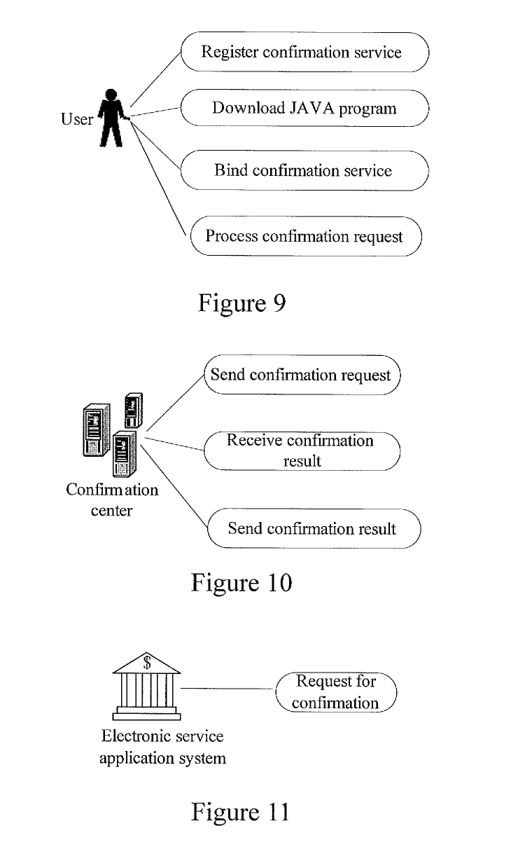

FIG. 9 is a schematic illustrating User-Centered Design (UCD) of a user in accordance with an embodiment of the present invention. FIG. 10 is a schematic illustrating the UCD of a confirmation center in accordance with an embodiment of the present invention. FIG. 11 is a schematic illustrating the UCD of an electronic service application system in accordance with an embodiment of the present invention.

An example of the present invention is described in detail hereinafter with reference to an example that liquid assets are protected by an electronic service notification system in an electronic-banking system.

It is supposed that the name of a bank is Bank 1 and that a User 1 open an account with the Bank 1. In this embodiment, the Bank 1 has already established a confirmation center and integrated the interface program of the confirmation center with the electronic-banking system.

Firstly, the User 1 registers a confirmation service in the confirmation center of the Bank 1.

Specifically, the user provides private information such as the number of a mobile terminal, and selects a valid ID corresponding to the number of the mobile terminal of the user. The confirmation center stores a corresponding relationship between the ID and the number of the mobile terminal.

Secondly, after the User 1 registers successfully, the confirmation center sends information on downloading a JAVA program to the mobile terminal of the User 1. The JAVA program is used to generate an electronic service confirmation result according to feedback from the user, and send the electronic service confirmation result to the confirmation center. If there is no the JAVA program, the JAVA program is downloaded and automatically installed in the mobile terminal of the User 1 according to the indication of the information on downloading the JAVA program. If there is already the JAVA program installed in the mobile terminal of the User 1, no JAVA program need be downloaded.

Thirdly, the User 1 binds the ID with the account of the Bank 1 at a business address or by telephone, and sets a notification and confirmation condition. For example, if the amount in the account is reduced by 100 Yuan at one time or is reduced by 200 Yuan in one day, the banking system notifies the User 1 automatically and waits for the confirmation result from the User 1. If receiving no reply of permission from the User 1 in a period of time, the banking system cancels the operation of reducing the amount in the account.

Fourthly, the User 1 initiates the online payment by the account of the Bank 1.

Fifthly, the banking system checks whether the payment amount meets the confirmation condition. If the payment amount does not meet the confirmation condition, the banking system processes the online payment according to the conventional manner. If the payment amount meets the confirmation condition, the banking system generates notification and confirmation information and sends a confirmation request to the confirmation center.

Sixthly, the confirmation center finds the number of a mobile terminal corresponding to the ID, and sends the confirmation information to the corresponding mobile terminal in a short message and activates the JAVA program in the mobile terminal.

Seventhly, the User 1 sends a confirmation result to the confirmation center via the JAVA program to permit the online payment.

Eighthly, the confirmation center sends to the electronic-banking system the confirmation result indicating permission of the payment.

Ninthly, the electronic-banking system processes the online payment.

In this embodiment, if the online payment is not initiated by the User 1 but by another person such as a hacker, the User 1 can monitor the online payment and send a confirmation result indicating refusal of the payment to the confirmation center via the JAVA program. The confirmation center sends the confirmation result indicating refusal of the payment to the electronic-banking system. The electronic-banking system cancels the online payment as so to stop the illegal electronic service and improve the security of the electronic service.

The foregoing are only embodiments of the present invention and are not for use in limiting the present invention, any modification, equivalent replacement or improvement made under the spirit and principles of the present invention is included in the protection scope thereof.

What is claimed is:

1. A system for confirming an electronic service, comprising: an electronic service application system, a confirmation center and a database; wherein
the electronic service application system is adapted to send an electronic service confirmation request to the confirmation center when implementing an electronic service, and implement the electronic service according to an electronic service confirmation result from the confirmation center;
the confirmation center is adapted to determine the confirmation terminal corresponding to the electronic service confirmation request, send an electronic service confirmation message to the confirmation terminal, and send the electronic service confirmation result from the confirmation terminal to the electronic service application system; and
the confirmation terminal is adapted to receive the electronic service confirmation message, generate the electronic service confirmation result according to feedback from a user, and send the electronic service confirmation result to the confirmation center.

2. The system according to claim 1, wherein the confirmation center sends the electronic service confirmation message to the confirmation terminal by a Short Message Service (SMS) protocol, a Socket protocol or a Datagram protocol.

3. The system according to claim 1, wherein the confirmation terminal comprises a mobile telephone, a Personal Digital Assistant (PDA), a Personal Computer (PC) or a laptop computer.

4. The system according to claim 1, wherein the electronic service application system comprises a bank account monitoring system, a telephone-banking transaction system, a network-banking transaction system, an electronic business transaction system, a liquid assets monitoring system, or a network cryptograph protection system.

5. The system according to claim 1, wherein the confirmation center comprises: an information transmission server, an application server and a database;
the information transmission server is adapted to receive the electronic service confirmation request, manage the application server to query the database for the confirmation terminal, send the electronic service confirmation message to the confirmation terminal in a communication mode registered by the confirmation terminal, and send the electronic service confirmation result from the confirmation terminal to the electronic service application system;
the application server is adapted to query the database for an identify ID and the communication mode of the confirmation terminal according to an instruction from the information transmission server; and
the database is adapted to store the ID of the confirmation terminal, the electronic service confirmation message and the electronic service confirmation result.

6. The system according to claim 5, wherein the database is further adapted to store private information of the user, and
the information transmission server is further adapted to receive registration of the user via an Internet Web connection or an Internet Socket connection of the confirmation terminal; and/or
the application server is further adapted to query for and/or modify the private information of the user according to a request from the information transmission server.

7. The system according to claim 5, wherein the communication mode registered by the confirmation terminal comprises: communicating with the confirmation center through a Short Message Service SMS protocol, a Socket protocol or a Datagram protocol, a Hyper Text Transport Protocol (HTTP).

8. The system according to claim 1, wherein the confirmation terminal comprises:
an electronic service confirmation module, adapted to generate the electronic service confirmation result according to the feedback from the user and the electronic service confirmation message.

9. A confirmation center of an electronic service, comprising one or more components adapted to:
receive an electronic service confirmation request from an electronic service application system, determine a confirmation terminal corresponding to the electronic service confirmation request, send an electronic service confirmation message to the confirmation terminal in a communication mode registered by the confirmation terminal, and send to the electronic service application system an electronic service confirmation result from the confirmation terminal.

10. The confirmation center according to claim 9, wherein the one or more components comprise: an information transmission server, an application server and a database;
the information transmission server is adapted to receive the electronic service confirmation request, manage the application server to query the database for the confirmation terminal, send the electronic service confirmation message to the confirmation terminal in the communication mode registered by the confirmation terminal, and send the electronic service confirmation result from the confirmation terminal to the electronic service application system;
the application server is adapted to query the database for an identity ID and the communication mode of the confirmation terminal according to an instruction from the information transmission server; and
the database is adapted to store the ID of the confirmation terminal, the electronic service confirmation message and the electronic service confirmation result.

11. The confirmation center according to claim 9, wherein the communication mode registered by the confirmation terminal comprises: communicating with the confirmation center through a Short Message Service (SMS) protocol, a Socket protocol or a Datagram protocol.

12. The confirmation center according to claim 9, wherein, the information transmission server comprises a Web server and a Socket server.

13. A mobile terminal, comprising one or more components adapted to:
receive an electronic service confirmation message from a confirmation center of an electronic service, generate an electronic service confirmation result according to feedback from a user, and send the electronic service confirmation result to the confirmation center.

14. The mobile terminal according to claim 13, wherein the one or more components comprise: a communication module receiving and sending information on electronic service confirmation, and an electronic service confirmation module;
the communication module is adapted to receive the electronic service confirmation message, and send the electronic service confirmation result generated by the electronic service confirmation module to the confirmation center of the electronic service; and
the electronic service confirmation module is adapted to generate the electronic service confirmation result according to the feedback from the user.

15. The mobile terminal according to claim 13, wherein the confirmation center of the electronic service is set in the mobile terminal in a mode of PUSH or Over-The-Air (OTA).

16. A method for confirming an electronic service, comprising:
sending, by an electronic service application system, an electronic service confirmation request to a confirmation center when implementing an electronic service;
determining, by the confirmation center, a confirmation terminal corresponding to the electronic service confirmation request, and sending an electronic service confirmation message to the confirmation terminal;
providing, by the confirmation terminal, the electronic service confirmation message to a user, generating an electronic service confirmation result according to feedback from the user, and sending the electronic service confirmation result to the confirmation center;
sending, by the confirmation center, the electronic service confirmation result from the confirmation terminal to the electronic service application system; and
implementing, by the electronic service application system, the electronic service according to the electronic service confirmation result.

17. The method according to claim 16, further comprising:
pre-setting a triggering condition of confirming the electronic service;
wherein the electronic service application system sends the electronic service confirmation request to the confirmation center if the triggering condition of confirming the electronic service is satisfied.

18. The method according to claim 16, wherein the electronic service confirmation message is encrypted.

19. The method according to claim 16, wherein the confirmation center sends the electronic service confirmation message to the confirmation terminal in a communication mode registered by the confirmation terminal.

20. The method according to claim 16, wherein implementing the electronic service according to the electronic service confirmation result comprises:
determining, by the electronic service application system, whether the electronic service is permitted according to the electronic service confirmation result;
implementing the electronic service only if the electronic service is permitted.
